(19) United States
(12) Patent Application Publication
(10) Pub. No.: US 2017/0175941 A1
(43) Pub. Date: Jun. 22, 2017

(54) APPARATUS AND METHOD FOR PLUGGING A PIPE

(71) Applicant: SOURCE 1 ENVIROMENTAL, LLC, Davison, MI (US)

(72) Inventor: Jeff Urbanski, Grand Blanc, MI (US)

(73) Assignee: SOURCE 1 ENVIROMENTAL, LLC, Davison, MI (US)

(21) Appl. No.: 15/129,118

(22) PCT Filed: Mar. 31, 2015
(86) PCT No.: PCT/US15/23559

§ 371 Date: Sep. 26, 2016

Related U.S. Application Data
(60) Provisional application No. 61/972,561, filed on Mar. 31, 2014.

(51) Int. Cl. F16L 55/1645; F16L 55/11

(52) U.S. Cl. CPC F16L 55/1645; F16L 55/1116

(57) ABSTRACT

A pipe lining assembly and a method for plugging a pipe line utilizing a pipe lining assembly are provided. The pipe lining assembly includes an inflatable bladder having a first end and a second end defining a cylindrical body, and a patch folded in a hat like shape disposed over the first end of the bladder. When the bladder is inflated inside a pipe line, the patch unfolds and plugs the pipe line i.e. stops fluid from flowing through the closed portion of the pipe line.

### CROSS REFERENCE TO RELATED APPLICATION

This PCT patent application claims the benefit of and priority to U.S. Provisional Patent Application Ser. No. 61/972,561 filed Mar. 31, 2014, entitled “Apparatus And Method For Plugging A Pipe”, the entire disclosure of the application is incorporated herein by reference.

### FIELD OF THE DISCLOSURE

The present disclosure generally relates to an apparatus and method for plugging a pipe, for example, a pipe running generally longitudinally from a building to a main pipe line.

### BACKGROUND OF THE DISCLOSURE

Municipalities, cities, and townships have numerous underground pipe lines or conduits designed to carry liquid such as, water or sewage throughout the area for commercial, industrial, and residential use. These pipe lines are typically designed in a straight pipe line and/or lateral pipe line configuration with one or more of a T or Y shaped junction. In particular, one or more lateral pipe lines may generally run from a building or multiple buildings into a main pipe line.

Overtime, various conditions or elements may affect either or both of the main and/or lateral pipe lines. For example, the pipe line or conduit may corrode or perforate and cause cracks to form within the pipe due to the age of the pipe, the material of pipe, and the type of liquid flowing throughout the pipe. Any cracks or damage to the pipe can cause leaks and may result in flooding, spillage of sewer around the pipe line, or decreases in water pressure effecting commercial and industrial entities inside the municipalities, cities, or townships as well as the residential areas utilizing water for non-recreational uses and recreational activities. As a result, the pipe line may be rendered useless to the municipality, city, or township. Apart from the elements, at other times, the pipe lines or conduits may not experience corrosion but instead may no longer be useful to a municipality, city, or township because of the pipe's placement or age. In either situation, the pipe lines may need to be removed.

In removing a pipe line, the municipality, city, or township may be required to hire an expensive pipe line removal service or contractor. The pipe line removal service or contractor must then cut out the pipe line by digging long trenches in the ground which disrupt and tear apart lawns, sidewalks, driveways, roads, and the like. Once the pipe line is removed, the removal service or contractor must 1) fill any holes left from the pipe line to other connecting pipe lines, 2) fill any trenches dug, and 3) reassemble the surrounding area to its previous form or condition prior to the pipe line removal. This process is not only very expensive for the municipality, city, and township, but is time consuming, drawn out, and disruptive to the everyday life of the individuals living in the surrounding area or to citizens passing through. Currently, there is not an assembly or process that is less time consuming or less expensive than the process discussed above. Thus, there is a need for an assembly and process for plugging, enclosing, or sealing off a pipe line which is less expensive, less time-consuming, and less invasive than removing the pipe line.

### SUMMARY OF THE DISCLOSURE

A pipe lining assembly for plugging a pipe and a method of plugging a pipe line utilizing a pipe lining assembly are provided.

An aspect of the pipe lining assembly includes an inflatable bladder having a first end and a second end defining a cylindrical body and a patch folded into a hat-like configuration. The patch is configured to receive one of the first end and the second end of the inflatable bladder. The patch is further configured to be disposed on one of the first end and the second end of the inflatable bladder and will unfold and plug the pipe line when the inflatable bladder is inserted into and is inflated in the pipe line.

An aspect of the pipe lining assembly includes an inflatable bladder and a patch folded into a hat-like configuration. The patch is made of bi-directional matting and is configured to be disposed on the inflatable bladder. The patch has a first edge, second edge, third edge, and fourth edge. The first edge is perpendicular to the second edge to form a first corner, the second edge is perpendicular to the third edge to form a second corner, the third edge is perpendicular to the fourth edge to form a third corner, and the fourth edge is perpendicular to the first edge to form a fourth corner. The first edge is parallel to the third edge and the second edge is parallel to the fourth edge. The first corner is folded into the third corner to form a triangle, the second corner is folded to a point along the fourth edge, and the fourth corner is folded to a point along the second edge to form the hat-like configuration.

An aspect of a method of plugging a pipe line utilizing a pipe lining assembly, the pipe lining assembly having an inflatable bladder and a patch includes providing the inflatable bladder and providing the patch. The patch has a first edge perpendicular to a second edge forming a first corner, the second edge is perpendicular to a third edge forming a second corner, the third edge is perpendicular to a fourth edge forming a third corner, and the fourth edge is perpendicular to the first edge forming a fourth corner and wherein the first edge is parallel to the third edge and the second edge is parallel to the fourth edge. The method also includes instructing a user to fold the patch into a hat-like configuration. The patch is configured to receive an end of the inflatable bladder. The method further includes instructing the user to place the patch over the end of the inflatable bladder, instructing the user to insert the pipe lining assembly into the pipe, and instructing the user to inflate the inflatable bladder to unfold the patch and plug the pipe.

The aspects disclosed herein provide various advantages. For example, a municipality, city, or township may have its employees or contractors use the assembly to plug a desired pipe line without having to hire an outside service or contractor. The assembly and method is a less expensive and less time consuming because the municipality, city, or township does not have to dig long trenches to remove the pipe line. Additionally, the assembly and method is a less invasive method of plugging a pipe line than when a pipe line is removed.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIGS. 1A and 1B are illustrations of a patch of a pipe lining assembly in accordance with the present disclosure;

FIG. 2 is an illustration of a first corner of a patch folded into a third corner of the patch in accordance with the present disclosure;

FIG. 3 is an illustration of a second corner of a patch folded into a point along a fourth edge of the patch in accordance within the present disclosure;

FIG. 4 is an illustration of a patch flipped over to facilitate further folding in accordance with the present disclosure;

FIGS. 5A and 5B are illustrations of a patch folded in a hat-like configuration for a pipe lining assembly in accordance with the present disclosure;

FIGS. 6A and 6B are perspective views of a patch in a hat-like configuration disposed on an inflatable bladder in accordance with the present disclosure;

FIG. 7 is a flowchart depicting a method of repairing a pipe utilizing a pipe lining assembly accordance with the present disclosure;

FIG. 8 is an illustration of a pipe lining assembly plugging a pipe in accordance with the present disclosure; and

FIG. 9 is an illustration of plugged pipe line in accordance with the present disclosure.

### DETAILED DESCRIPTION OF THE PRESENT DISCLOSURE

Detailed examples of the present disclosure are disclosed herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure. As those of ordinary skill in the art will understand various features of the present disclosure as illustrated and described with reference to any of the Figures may be combined with features illustrated in one or more other Figures to produce examples of the present disclosure that are not explicitly illustrated or described.

The aspects disclosed herein show a pipe lining assembly and a method for plugging a pipe utilizing a pipe lining assembly. The pipe lining assembly and the method for plugging a pipe utilizing a pipe lining assembly is configured to enclose or “plug” the pipe to prevent the flow of liquid throughout. The pipe lining assembly includes an inflatable bladder and a patch folded in a hat-like configuration. The patch is configured to be disposed on an end of the inflatable bladder. The patch is further configured unfold and plug the pipe by adhering to the inner surface of the pipe when the inflatable bladder is inflated. The patch or plug stops or prevents the flow of fluid throughout the pipe. The inflatable bladder can be any type of bladder such as a bladder having a straight or main leg and/or a T or Y shaped leg. The patch can also “plug” any type of pipe line including, but is not limited to, a main pipe line, a lateral pipe line running longitudinally from a main pipe line, and a connection or junction between a main and lateral pipe lines. Additionally, one skilled in the art appreciates that the term “plug” is interchangeable with the term “seal,”, “sealed,” “sealing off,” “enclosure,” “enclosed,” “closure,” “stop,” “stopped,” “stopper,” or any term associated with closing or sealing off a pipe line to prevent and/or stop the flow of water, sewage, fluid, or any liquid to another pipe line or to a building.

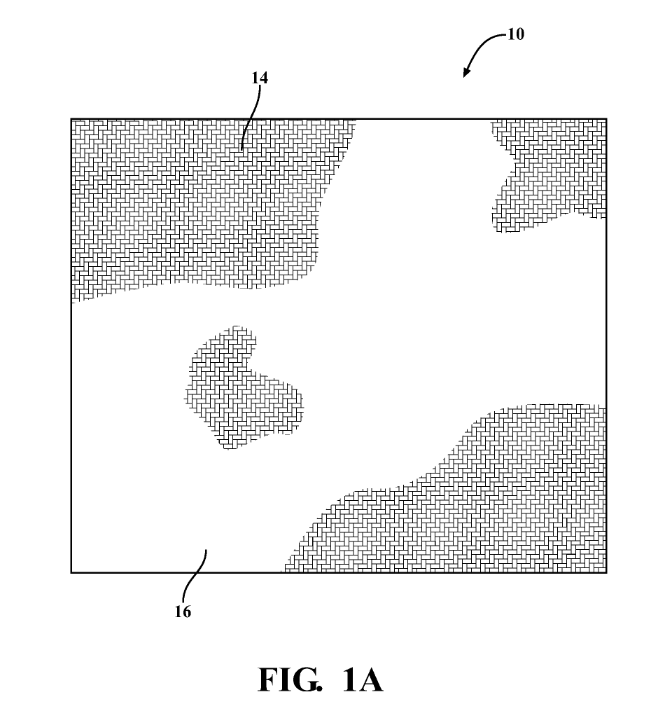

FIGS. 1A-5B are various illustrations of a patch 10 being folded into a hat-like configuration in accordance with the present disclosure. In particular, FIG. 1A shows a patch 10 in an unfolded configuration of a pipe lining assembly 12. The patch 10 is made of a fibrous material 14 such as fiberglass and is made of a bi-directional or woven matting, which can include one or more layers of material. The patch 10 is made of a bi-directional fiberglass to maximize strength of the patch and to assist in bonding resin to the fiberglass. The patch 10 is configured to be folded in any direction. One or both sides of the patch 10 is covered or impregnated with a resin 16 or another polymeric material known in the art that is capable of hardening and curing. The patch 10 has a predetermined size depending on and corresponding to the size of the pipe to ensure proper closure of a crack or the entire pipe line. The patch 10 may have a rectangle-like shape, as shown in FIG. 1A. Additionally, the patch 10 may initially have a rectangle-like shape and may be further folded in half to achieve a square-like shape, as shown in FIG. 1B. Alternatively, the patch 10 may initially have a square-like shape. In FIG. 1B, the patch 10 is folded in half and has a sheet (not shown) disposed between the fold to prevent the patch's material from sticking together. The sheet is a plastic sheet.

The patch 10 has a first edge 18, a second edge 20, a third edge 22, and a fourth edge 24. The first edge 18 is perpendicular to the second edge 20, which forms a first corner 26. The second edge 20 is perpendicular to the third edge 22, which forms a second corner 28. The third edge 22 is perpendicular to the fourth edge 24, which forms a third corner 30. The fourth edge 24 is perpendicular to the first edge 18, which forms a fourth edge 32. The first edge 18 is parallel to the third edge 22 and the second edge 20 is parallel to the fourth edge 24. It is appreciated by one skilled in the art that the corners discussed above may have a square or rounded shape depending on the shape of the patch 10.

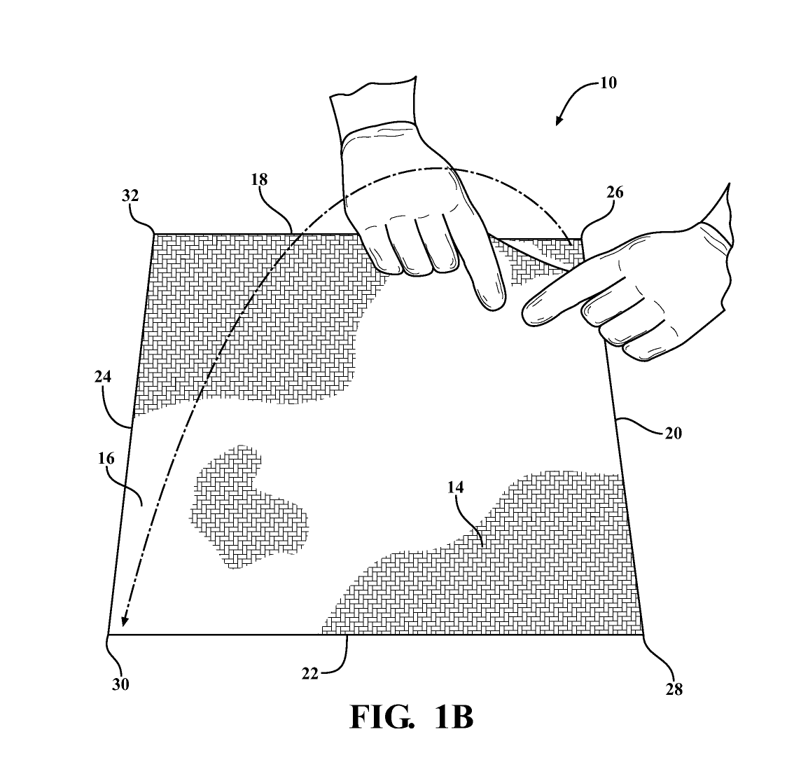

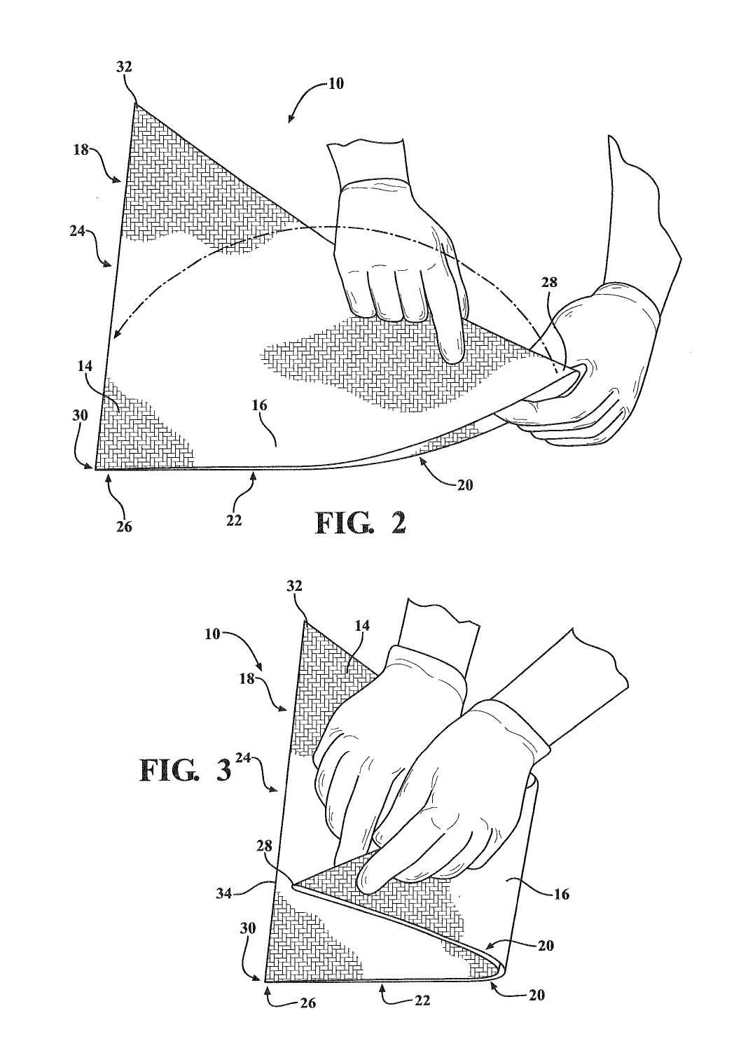

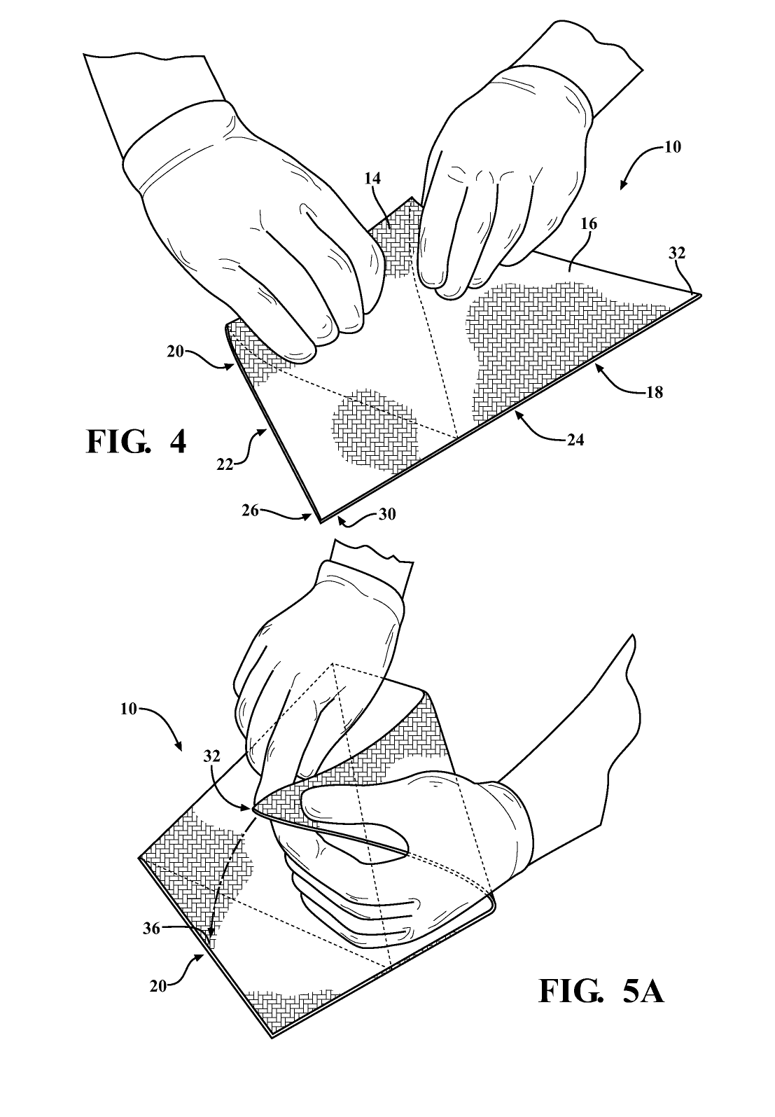

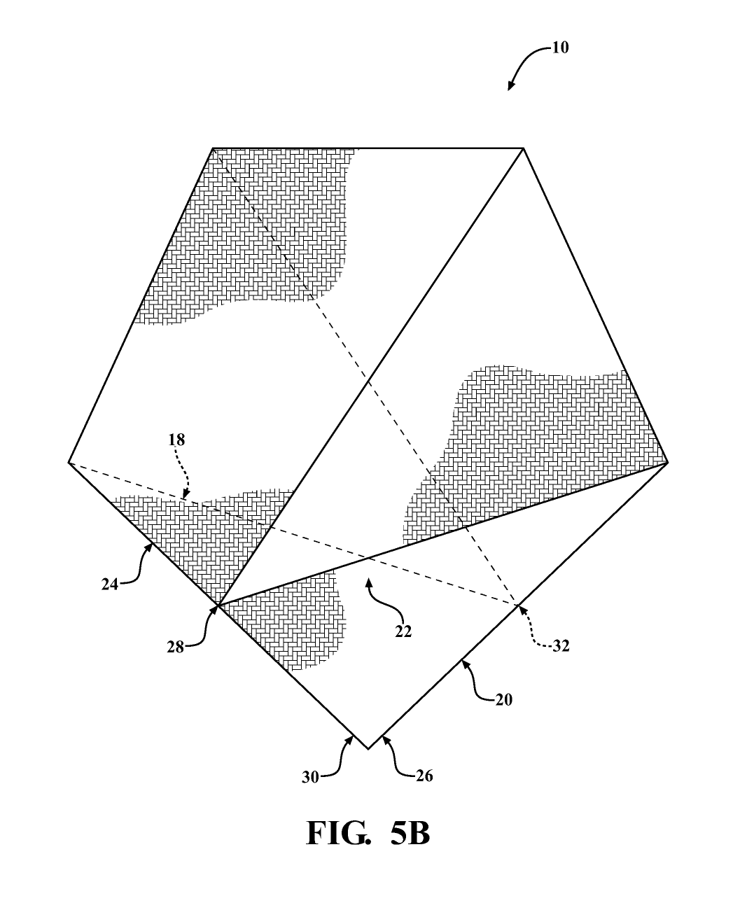

To form the hat-like configuration, the first corner 26 of the patch 10 is folded to the third corner 30 to form a triangle, as shown in FIG. 2. Next, as shown in FIG. 3, the second corner 28 is folded to a point 34 along the fourth edge 24 of the patch 10. The point 34 may be anywhere along the fourth edge 24. The patch 10 is flipped over and the opposite side of the patch 10 is face up, as shown in FIG. 4. In FIG. 5A, the fourth corner 24 is folded to a point 36 along the second edge 20 to form the hat-like configuration. FIG. 5B shows the patch 10 in the hat-like configuration. The patch 10 folded into the hat-like configuration is configured to receive an end of an inflatable bladder 38 of the pipe lining assembly 12. In particular, the first corner 26 and the third corner 30 of the patch 10 open to receive the end of the bladder.

It is important to note that the patch 10 is folded into the hat-like configuration to unfold or open easily and attach to the pipe to act as a plugging mechanism. In other words, the patch 10 unfolds, attaches to the inner surface of the pipe, hardens and cures, and plugs the pipe or acts as a patch to prevent any fluid from flowing through to another pipe or to a building. The patch 10 may also be in the hat-like configuration to easily fit on and be secured to the inflatable bladder 38. A stitch (not shown) is placed along one or more points of the patch 10 folded in the hat-like configuration for maintaining the placement of the sheet within the patch 10 as discussed above.

One skilled in the art appreciates that such a patch that is made of a bi-directional fiberglass with one or more layers may be used in other configurations to either plug a pipe line or repair a crack within a pipe line. For example, the patch may be wrapped around a circular or cylindrical body or wrapped within a bladder with a foldable body. In such configuration, the patch has a first edge, a second edge, a third edge, and a fourth edge with each respective corner. The patch is wrapped around the inflatable bladder with the first edge and the third edge being disposed on one another.

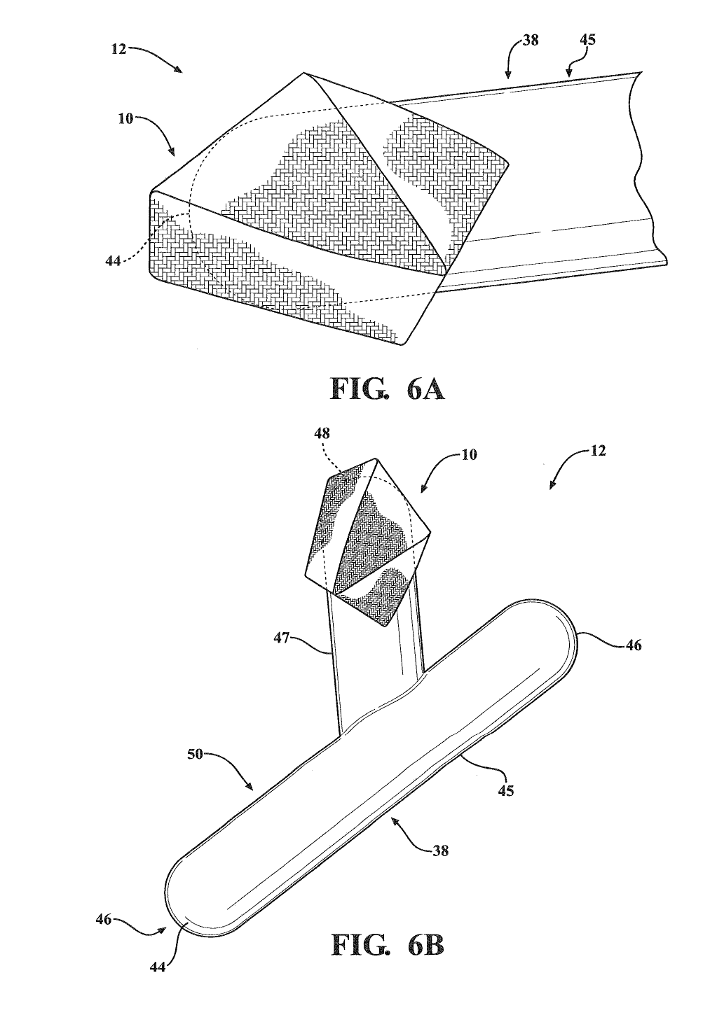

With respect to FIGS. 6A and 6B, perspective views of the patch 10 folded in the hat-like configuration disposed on the inflatable bladder 38 are provided. In particular, FIG. 6A illustrates the patch 10 in the hat-like configuration disposed on the inflatable bladder 38 having a straight pipe line configuration 40 and FIG. 6B illustrates the patch 10 in a hat-like configuration disposed on the inflatable bladder 38 having a lateral pipe line configuration 42. The straight pipe line configuration 40 has a first end 44 and a second end 46 defining a cylindrical body 45. The lateral pipe line configuration 42 will have a T or Y shape with main tube or cylindrical body 45 and a lateral tube 47 extending from the main tube 45. Furthermore, the inflatable bladder 38 may be any type of bladder known to one skilled in the art, including but not limited to, a bladder configured to fold into a cylindrical shape or tube-like shape or a bladder preassembled in a cylindrical shape or tube-like shape. The inflatable bladder 38 of both FIGS. 6A and 6B include a first end 44 and a second end 46. In the instance of the inflatable bladder 38 having the lateral pipe line configuration 40, the inflatable bladder 38 also includes a third end 48. The patch 10 is configured to be disposed on one of the first end 44, the second end 46, and the third end 48 of the inflatable bladder 38. In FIG. 6A, the patch 10 is shown on the first end 44 of the inflatable bladder 38 and in FIG. 6B, the patch 10 is on the third end 48 of the inflatable bladder 38. As discussed above, the first corner 26 and the third corner 30 of the patch 10 open to allow the patch 10 to receive the inflatable bladder 38.

The inflatable bladder 38 also has a sealed chamber 50 configured to receive air or other fluid and receives air or other fluid via an inlet 52 located thereon. The inflatable bladder 38 is inflatable and is configured to inflate up to three times its size when inserted into the pipe line.

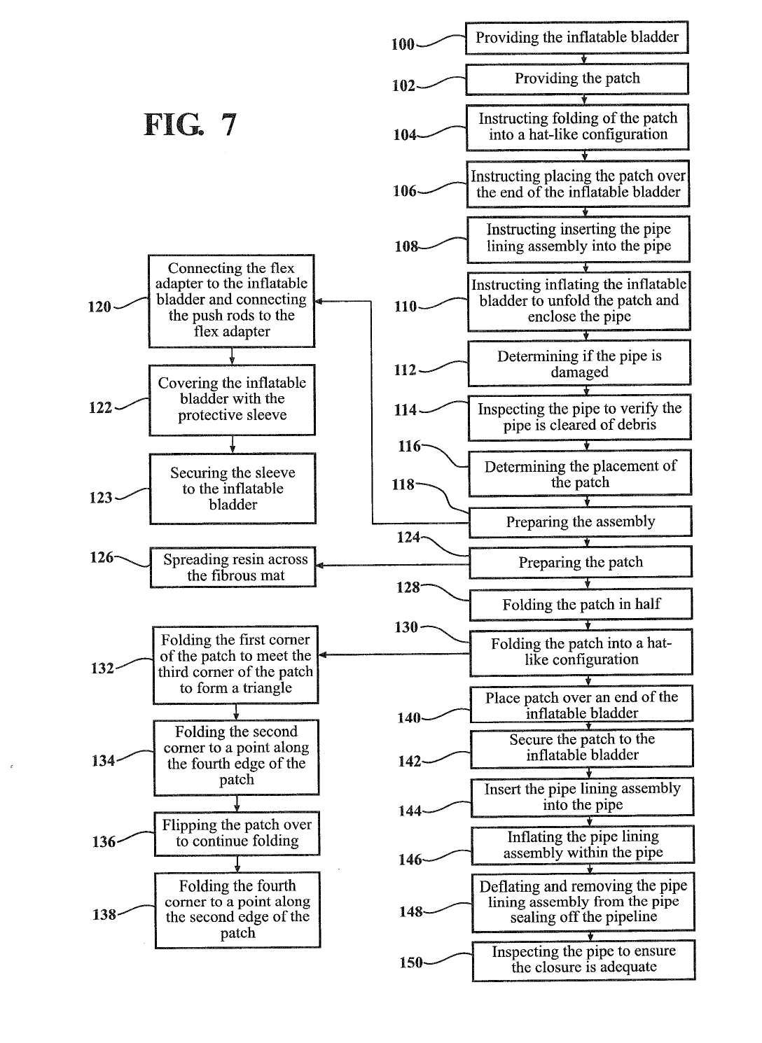

FIG. 7 is a flowchart depicting a method of plugging a pipe utilizing a pipe lining assembly. The method includes providing the inflatable bladder 100, providing the patch 102, and instructing a user to fold the patch into a hat-like configuration 104. The patch is configured to receive an end of the inflatable bladder. The method also includes instructing the user to place the patch over the end of the inflatable bladder 106, instructing the user to insert the pipe lining assembly into the pipe 108, and instructing the user to inflate the inflatable bladder to unfold the patch and plug the pipe 110.

The method further includes instructing the user to inspect the pipe to determine if the pipe is damaged, useless, or must be plugged and clearing the pipe of all debris 112. The method also includes instructing the user to inspect the pipe to verify the pipe is cleared of all debris 114. For instance, the user of the bladder (or assembly) lowers a camera into the pipe to view damage within the pipe. The camera is also used as a device to measure the pipe line to determine the placement of the patch on the inflatable bladder 116. The pipe lining assembly is then prepared 118. To prepare the assembly 118, a flex adapter is connected to the inflatable bladder via the inlet and push rods are connected to the flex adapter 120.

The method further includes instructing the user to cover the inflatable bladder with the protective sleeve 122. The protective sleeve is secured to the bladder using an adhesive material 123. The adhesive material is vinyl tape or any adhesive material that is water sealed or waterproof.

After the protective sleeve is secured to the bladder 123, the patch is prepared 124. To prepare the patch 124, the polymeric material such as resin is spread across a fibrous mat 126. The patch is then folded in half to create a smaller rectangle-like or square-like patch and create multiple layers of matting 128.

The patch has the characteristics of the patch described in FIG. 1A-5B. The patch has a first edge perpendicular to a second edge and a third edge perpendicular to a fourth edge. The first edge of the patch is parallel to the third edge and the second edge of the patch is parallel to the fourth edge. The patch also has a first corner formed by the first edge and the second edge, a second corner formed by the second edge and the third edge, a third corner formed by the third edge and the fourth edge, and a fourth corner formed by the fourth edge and the first edge. The patch is folded into a hat-like configuration 130. First, the first corner of the patch is folded to meet the third corner of the patch to form a triangle 132. Next, the second corner of the patch is folded to a point along the fourth edge of the patch 134. The patch is then be flipped over to continue folding 136. After the patch has been flipped over the fourth corner of the patch is folded to a point along the second edge 138, thus forming the hat-like configuration.

After the patch has been completely folded 130, the patch is placed over an end of the bladder 140. In this step, the patch completely covers the end of the bladder. The patch is secured to the inflatable bladder with one or more fastening device to maintain the hat-like shape or configuration of the patch 142. For instance, the patch is secured by a twist tie. The pipe lining assembly is then prepared to be inserted into the pipe which will be plugged or enclosed.

The pipe lining assembly is inserted into the pipe using one or more pull cable connected to one or more metal link disposed at the opposite end of the bladder from the patch 144. Once the bladder is inserted into the pipe 144, the bladder is inflated inside the pipe to a specified pressured based on the size of the pipe 146. The bladder is inflated via the air regulator and the air compressor, which allows the patch to expand and bind to the inside of the pipe creating a plug and sealing off the pipe. The bladder expands up to three times in size to create the plug or closure.

After a predetermined amount of time has lapsed the bladder is deflated and removed from the pipe leaving the patch behind which plugs or seals off the pipe line for present and future use 148. Once the pipe is plugged or closed, no water or sewage will flow into or out of the pipe. The predetermined amount of time is around one to three hours. Lastly, the pipe is inspected using the camera to ensure the plug or closure is adequate 150.

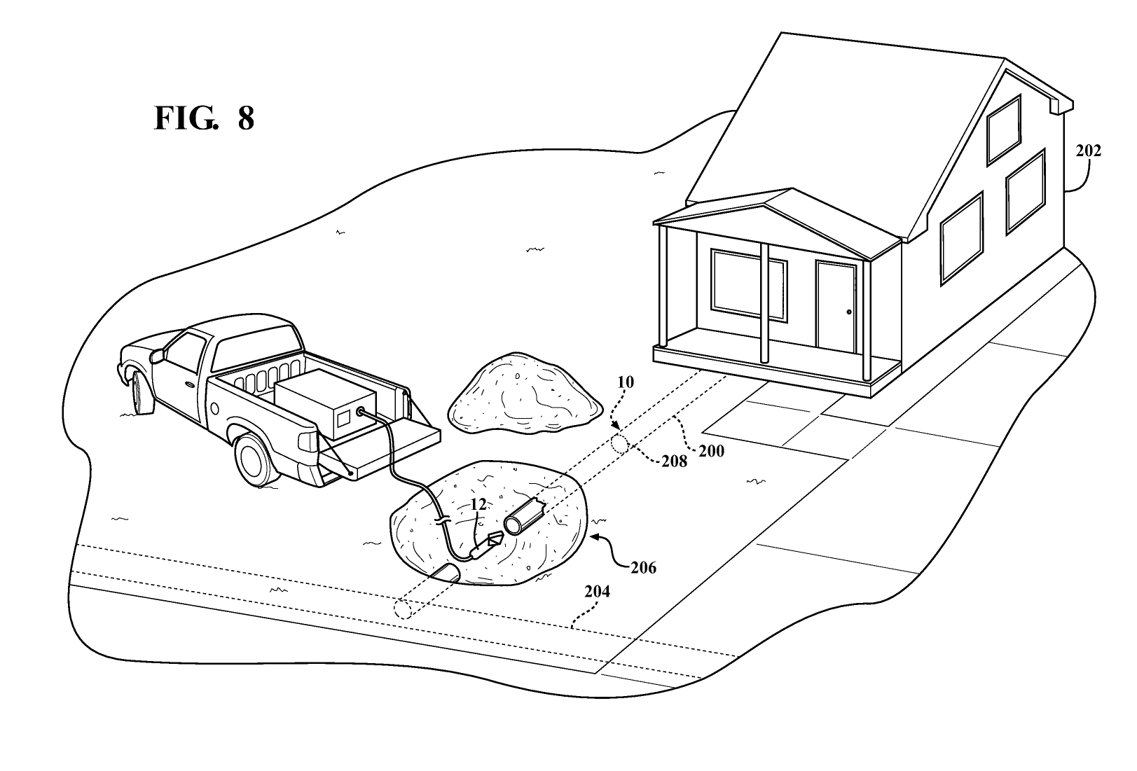

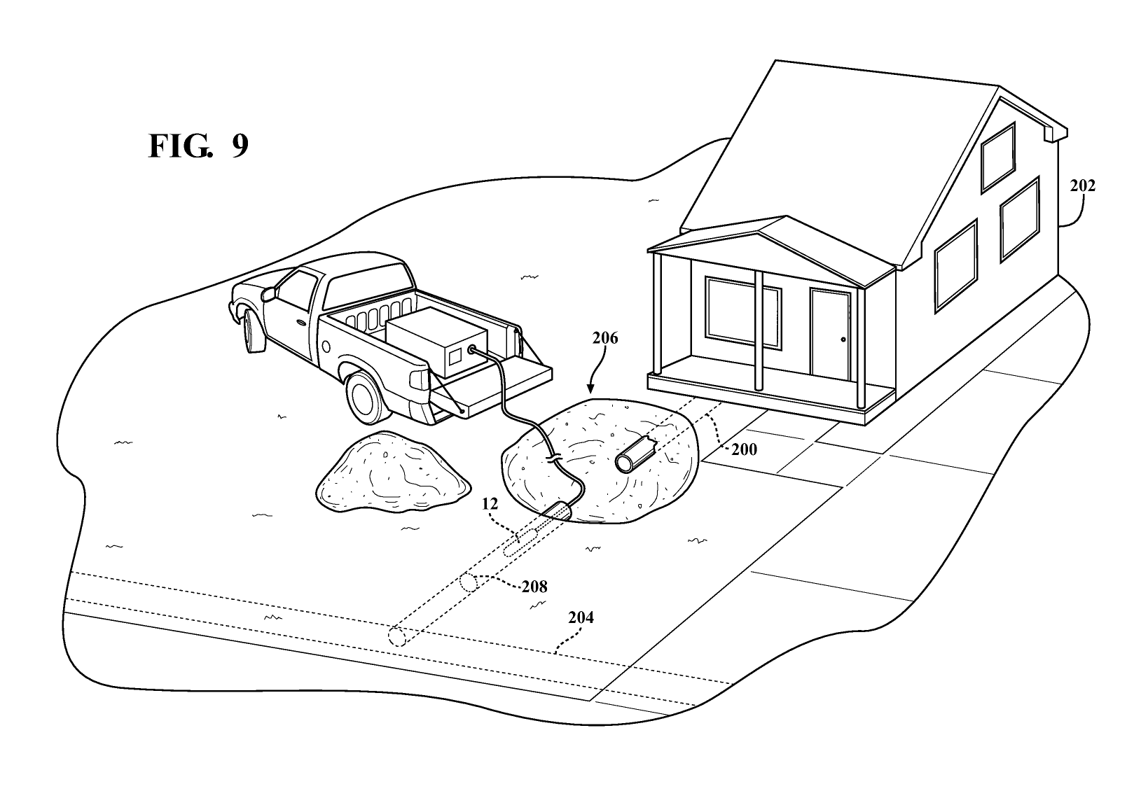

With respect to FIG. 8, an illustration of a pipe lining assembly 12 and method of plugging a pipe line utilizing the pipe lining assembly 12 in accordance with the present disclosure is provided. Specifically, FIG. 8 demonstrates the pipe lining assembly with the bladder and the hat-like patch lowered into a lateral pipe line 200 leading to a house 202 and to a main pipe line 204. The inflatable bladder 38 is lowered into the main pipe line 204 or lateral pipe line 200 from an access point 206. The access point 206 is a point within the house 202, outside the house 202, or another point which leads to the main pipe line 204 or lateral pipe line 200. Once the bladder 38 is inserted in the respective pipe line, the bladder 38 is inflated, the patch 10 unfolds to fit the pipe line, and the patch 10 creates a plug or closure 208. The bladder 38 is removed leaving the plug in the lateral pipe line 200, as shown in FIG. 9. Additionally, it is appreciated by one skilled in the art that the patch 10 and inflatable bladder 38 is used to plug or seal any pipe line. For instance a main or lateral pipe line 204, 200 and the patch 10 or multiple patches is used on the same bladder 38 to either plug multiple areas of one or more pipe lines or to plug one pipeline another pipe line from cracks and corrosion.

1. A pipe lining assembly for plugging a pipe, comprising:
an inflatable bladder having a first end and a second end defining a cylindrical body;
a patch having a first edge, a second edge, a third edge, and a fourth edge;
wherein the first edge is generally perpendicular to the second edge forming a first corner, the second edge is generally perpendicular to the third edge forming a second corner, the third edge is generally perpendicular to the fourth edge forming a third corner, and the fourth edge is generally perpendicular to the first edge forming a fourth corner;
wherein the first corner is folded to the third corner, the second corner is folded to a point along the fourth edge, and the fourth corner is folded to a point along the second edge to form a hat-like configuration; and
the patch being configured to receive one of the first end and the second end of the inflatable bladder between the first and third corners of the patch while the patch is formed in the hat-like configuration,
wherein the patch is configured to unfold from the hat-like configuration and plug the pipe when the inflatable bladder is inserted into and inflated in the pipe.

2. (canceled)

3. A pipe lining assembly for plugging a pipe, comprising:
an inflatable bladder; and
a patch folded into a hat-like configuration, the patch being configured to be disposed on the inflatable bladder,
wherein the patch has a first edge perpendicular to a second edge forming a first corner, the second edge is perpendicular to a third edge forming a second corner, the third edge is perpendicular to a fourth edge forming a third corner, and the fourth edge is perpendicular to the first edge forming a fourth corner,
wherein the first edge is parallel to the third edge and the second edge is parallel to the fourth edge, and
wherein the first corner is folded to the third corner to form a triangle, the second corner folded to a point along the fourth edge, and the fourth corner folded to a point along the second edge to form the hat-like configuration.

4. The pipe lining assembly of claim 3, wherein the inflatable bladder has a first end and a second end defining a cylindrical body.

5. The pipe lining assembly of claim 4, wherein the inflatable bladder has a third end extending outwardly from the cylindrical body forming one of a T and Y shaped configuration.

6. The pipe lining assembly of claim 4, wherein the patch is configured to be disposed on one of the first end, the second end, and the third end, and wherein the patch is configured to unfold and plug the pipe when the inflatable bladder is inserted and is inflated in the pipe.

7. The pipe lining assembly of claim 4, wherein the patch is made of a bi-directional fibrous material.

8. The pipe lining assembly of claim 7, wherein the fibrous material is a fiberglass mat.

9. The pipe lining assembly of claim 7, wherein the fibrous material is impregnated with resin.

10. A method of plugging a pipe utilizing a pipe lining assembly, the pipe lining assembly having an inflatable bladder and a patch, comprising:
providing the inflatable bladder;
providing the patch, wherein the patch has a first edge perpendicular to a second edge forming a first corner, the second edge is perpendicular to a third edge forming a second corner, the third edge is perpendicular to a fourth edge forming a third corner, and the fourth edge is perpendicular to the first edge forming a fourth corner, and wherein the first edge is parallel to the third edge and the second edge is parallel to the fourth edge;
instructing a user to fold the patch into a hat-like configuration, the patch is configured to receive an end of the inflatable bladder;
instructing the user to place the patch over the end of the inflatable bladder;
instructing the user to insert the pipe lining assembly into the pipe; and
instructing the user to inflate the inflatable bladder to unfold the patch and plug the pipe.

11. The method of claim 10, wherein folding the patch into a hat-like configuration further includes:
folding the patch in half to create a square-like shape.

12. The method of claim 11, further including:
folding the first corner to the third corner of the patch forming a triangle;
folding the second corner to a point along the fourth edge of the patch;
flipping the patch over; and
folding the fourth corner to a point along the second edge of the patch.

13. The method of claim 10, further including:
securing the patch to the inflatable bladder.

14. The method of claim 10, further including:
deflating the inflatable bladder; and
removing the inflatable bladder from the pipe after a predetermined amount of time,
wherein the patch plugs the pipe when the inflatable bladder is removed.
